(19) United States
(12) Patent Application Publication
(10) Pub. No.: US 2023/0052060 A1
(43) Pub. Date: Feb. 16, 2023

(54) EQUILIBRIUM CALCULATION APPARATUS, EQUILIBRIUM CALCULATION METHOD AND PROGRAM

(71) Applicant: NIPPON TELEGRAPH AND TELEPHONE CORPORATION, Tokyo (JP)

(72) Inventors: Kengo NAKAMURA, Tokyo (JP); Shinsaku SAKAUE, Tokyo (JP); Norihito YASUDA, Tokyo (JP)

(73) Assignee: NIPPON TELEGRAPH AND TELEPHONE CORPORATION, Tokyo (JP)

(21) Appl. No.: 17/787,859

(22) PCT Filed: Dec. 24, 2019
(86) PCT No.: PCT/JP2019/050675

§ 371 Date: Jun. 21, 2022

(51) Int. Cl. A63F 13/822; A63F 13/77

(52) U.S. Cl. CPC A63F 13/822; A63F 13/77; A63F 2300/807; A63F 2300/535

(57) ABSTRACT

An equilibrium state calculation apparatus according to an embodiment is an equilibrium state calculation apparatus for calculating an equilibrium state of a congestion game. The equilibrium state calculation apparatus includes an input unit input with graph information representing a set of strategies represented by a combination of items, in a zero-suppressed binary decision diagram, the strategies used by a player of the congestion game, and a calculation unit that calculates, by using the graph information input through the input unit, equilibrium state information including a proportion of players selecting the strategies in the equilibrium state by a variant of the Frank-Wolfe algorithm.

### TECHNICAL FIELD

The present invention relates to an equilibrium state calculation apparatus, an equilibrium state calculation method, and a program.

### BACKGROUND ART

A congestion game is known as one of non-cooperative games in game theory. The congestion game is modeling of a situation where mutually non-cooperative players compete for some resources or a situation where resources are allocated to mutually non-cooperative players. In the Selfish Routing, which is a type of the congestion game, it is possible to model a situation where many people (players) each attempt to communicate between two points with a small delay in a communication network including communication paths with an increased delay along with an increased amount of communication, and a situation where players each attempt to move between two points in a short time in a road network including roads requiring a longer hours as the traffic volume increases, for example. The congestion game is obtained by further generalizing the Selfish Routing so that it is possible to handle a wide range of strategy sets, and thus, it is possible to handle, for example, a situation where many people attempt to perform a communication among multi points with a small delay, and a situation where even in a case of communication between two points, a billing amount is set irrespective of delay of communication paths, and communication is performed limitedly to communication routes available within a budget billing amount.

Here, in the congestion game, each of players is to select a combination of items S⊆[n] for an item set [n]:={1, . . . , n}. Note that combinations of items to be selected are predetermined, a set of such combinations is the strategy set, and an element in the strategy set (that is, a combination of items) is called a strategy. Each of the items is set to be higher in cost as a proportion of players selecting such an item increases, and a cost for each of the players is a sum of the costs of items in a selected strategy. At this time, each player does not cooperate with one another and attempts to seek a strategy with a cost as low as possible for only the benefit of the player.

For example, with a graph structure obtained by abstracting communication networks, road networks, or the like, the Selfish Routing is a congestion game where an item is each side of the graph structure, and the strategy set is a set of combinations of items represented by a path from one vertex to another on the graph structure. Similarly, the above-described situation where players perform communication among multi points may be modeled as a congestion game where the strategy set is the Steiner tree with a certain vertex set on the graph structure as a terminal, and the situation where communication is performed limitedly to a certain billing amount may be modeled as a congestion game where the strategy set is a set of combinations of items represented by a path available within the certain billing amount in paths from a certain vertex to a certain vertex on the graph structure.

An important state in the congestion game includes a state called an equilibrium state. The equilibrium state is a state in which players are not dissatisfied, that is, a state which each of mutually non-cooperative players finally reaches as a result of aiming at a state with a minimum cost. If it is possible to calculate the equilibrium state in the congestion game, when, for example, a communication network or a road network is designed, it is possible to simulate a level of congestion generated on each communication path and road due to the design or an actual cost for players.

Until now, there have been proposed techniques for approximately obtaining an equilibrium state in the Selfish Routing. For example, a technique has been proposed in which an equilibrium state in the Selfish Routing is evaluated by theoretical polynomial time by repeatedly using a flow algorithm on a graph structure (NPL 1). Furthermore, a well-known practical method of calculating an equilibrium state includes an optimization algorithm called Frank-Wolfe algorithm (NPLs 2 and 3).

It is also known that it is possible to calculate an equilibrium state in a general congestion game by using the Frank-Wolfe algorithm while holding all elements in a strategy set.

### CITATION LIST

### Non Patent Literature

NPL 1: Alex Fabrikant, Christos Papadimitriou, and Kunal Talwar. The complexity of pure Nash equilibria. In Proceedings of the 36th Annual ACM Symposium on Theory of Computing, pp. 604-612, 2004.

NPL 2: Marguerite Frank and Philip Wolfe. An algorithm for quadratic programming. Naval Research Logistics Quarterly, Vol. 3, pp. 95-110.

NPL 3: Jose R. Correa and Nicolas Stier-Moses. Wardrop Equilibria. In Wiley Encyclopedia of Operations Research and Management Science.

### SUMMARY OF THE INVENTION

### Technical Problem

However, the number of elements in a set of combinations, such as a strategy set, is at most 2ⁿ relative to the size n of the original set of items [n] and is often generally exponentially large. Thus, if all of the elements of the strategy set are held, a large amount of cost for a calculation time and memories is required, and for example, it is often practically impossible to evaluate an equilibrium state even if n is about several tens.

An embodiment of the present invention has been made in view of the above-described circumstances, and an object thereof is to calculate an equilibrium state of a congestion game.

### Means for Solving the Problem

To achieve the above object, an equilibrium state calculation apparatus according to an embodiment is an equilibrium state calculation apparatus for calculating an equilibrium state of a congestion game. The apparatus includes an input unit input with graph information representing a set of strategies represented by a combination of items, in a zero-suppressed binary decision diagram, the strategies used by a player of the congestion game, and a calculation unit that calculates, by using the graph information input through the input unit, equilibrium state information including a proportion of players selecting the strategies in the equilibrium state by a variant of the Frank-Wolfe algorithm.

### Effects of the Invention

It is possible to calculate an equilibrium state of a congestion game.

### BRIEF DESCRIPTION OF DRAWINGS

FIG. 1 is a diagram illustrating an example of an entire configuration of an equilibrium state calculation apparatus according to the present embodiment.

FIG. 2 is a flowchart illustrating an example of equilibrium state calculation processing according to the present embodiment.

FIG. 3 is a flowchart illustrating an example of correction processing according to the present embodiment.

FIG. 4 is a diagram illustrating an example of a hardware configuration of the equilibrium state calculation apparatus according to the present embodiment.

### DESCRIPTION OF EMBODIMENTS

Hereinafter, an embodiment of the present disclosure will be described. In the present embodiment, an equilibrium state calculation apparatus 10 capable of calculating an equilibrium state of a congestion game will be described.

The equilibrium state calculation apparatus 10 according to the present embodiment incorporates a zero-suppressed binary decision diagram (hereinafter referred to as “ZDD”) into the Frank-Wolfe algorithm to enable high-speed calculation of an equilibrium state of a general congestion game not depending on a strategy set.

In particular, in the present embodiment, the Fully-corrective Frank-Wolfe algorithm and the Away-step Frank-Wolfe algorithm, which are variants of the Frank-Wolfe algorithm, are employed for the Frank-Wolfe algorithm. As a result, the equilibrium state calculation apparatus 10 according to the present embodiment may obtain an equilibrium state with a guaranteed approximate accuracy.

Note that the ZDD is a structure allowing for compact expression of a combination set such as a strategy set. For example, a set of paths from one vertex to another on the graph structure, a set of the Steiner trees, and a set of paths satisfying billing amount restrictions may be all expressed by the ZDD. ZDD representing a combination set may be constructed, for example, by the Frontier-based method. In addition, Graphillion and the like are known as libraries using the Frontier-based method. With such libraries, it is possible to build the ZDD efficiently. For the Frontier-based method, for example, refer to References Document 1 “Jun Kawahara, Takeru Inoue, Hiroaki Iwashita, and Shin-ichi Minato. Frontier-based search for enumerating all constrained subgraphs with compressed representation. IEICE TRANSACTIONS on Fundamentals of Electronics, Communications and Computer Sciences, Vol. E100-A, pp. 1773-1784, 2017.” and the like. For Graphillion, for example, refer to Reference Document 2 “GitHub—takemaru-graphillion Fast, lightweight graphset operation library, the Internet <URL:https://github.com/takemaru/graphillion/>” and the like.

In addition, for ZDD, for example, refer to Reference Document 3 “Shin-ichi Minato. Zero-suppressed BDDs for set manipulation in combinatorial problems. In Proceedings of the 30th ACM/IEEE Design Automation Conference, pp. 272-277, 1993.” and the like. For the Fully-corrective Frank-Wolfe algorithm and the Away-step Frank-Wolfe algorithm, for example, refer to Reference Document 4 “Simon Lacoste-Julien and Martin Jaggi. On the global linear convergence of Frank-Wolfe optimization variants. In Proceedings of the 28th International Conference on Neural Information Processing Systems, Vol. 1, pp. 496-504, 2015”.

### Congestion Game

Firstly, the congestion game will be described. In the congestion game, each item of an item set [n]:={1, . . . , n} is applied with a monotonically non-decreasing cost function cᵢ(yᵢ) for a usage rate yᵢ. Also, for the item set [n], players each select a combination of items S⊆[n]. Note that combinations of items to be selected are predetermined. A set of such combinations is a strategy set:

S={S₁, . . . , S_{|S|}} [Math. 1]

An element (that is, a combination of items) in the strategy set is referred to as strategy. The congestion game discussed in the present embodiment is assumed to include many players, and a proportion z_{S} of the players selecting, for each strategy S, such a strategy will be considered. Note that

Σ_{S∈S}^{z}S=1 [Math. 2]

Once the proportion of players selecting, for each strategy, the strategy is determined, a usage rate yᵢ of an item i can be evaluated by obtaining a sum of the proportions of players selecting a strategy including the item i, that is, according to the following equation:

yᵢ=Σ_{S∈S:i∈S}^{z}S [Math. 3]

If c_{S} denotes a cost of the strategy S, the cost may be evaluated by obtaining a sum of costs of items included in the strategy S, that is, according to the following equation:

c_{S}=Σ_{i∈S}cᵢ(yᵢ) [Math. 4]

At this time, each player does not cooperate with one another and attempts to seek a strategy with a cost as low as possible for only the benefit of the player. Thus, if a certain player finds a strategy less costly than a currently selected strategy, then the cost may be reduced by reselecting the less costly strategy. As such, the player will change the strategy. A state without such a change in strategy is an equilibrium state called a Wardrop equilibrium state. The Wardrop equilibrium state is defined as a state where the cost is minimum of all strategies for a strategy with a proportion of players being more than 0, that is, a state where the following:

For all S∈S z_{S}>0⇒c_{S}=min_{s′∈S}c_{S′} [Math. 5]

is established.

The above-described congestion games will be more generalized to describe a case where different players use different strategy sets. In this case, if [r] denotes a set of r player groups, the number of strategy sets is not one, and a plurality of types of r strategy sets:

S¹, . . . , S^{r} [Math. 6]

are given, and a proportion m^{l}, . . . , m^{r} of players using each of the strategy sets is assumed to be given at the same time. The player group is a set of 0 or greater players. Note that

Σₚ₌₁^{r}m^{r}=1 [Math. 7]

holds.

In this situation, for each player group p∈[r], for each strategy:

S∈S^{p} [Math. 8]

the proportion zs^{p} of players selecting the strategy will be considered. Note that

Σ_{S∈S}z_{S}^{p}=1 [Math. 9]

holds.

If the above proportion zₛ^{p} is determined, when

xᵢ^{p}=Σ_{S∈S}_{^{p}}_{i∈S}z_{S}^{p} [Math. 10]

is used, the usage rate of each item may be calculated as follows:

yᵢ=Σₚ₌₁^{r}m^{p}xᵢ^{p} [Math. 11]

Thus, the cost of the strategy S may be calculated as follows:

c_{S}=Σ_{i∈S}cᵢ(yᵢ) [Math. 12]

At this time, the Wardrop equilibrium state is defined as a state where the cost is minimum out of the strategies in such a strategy set for a strategy with the proportion of players being more than 0, that is, a state where the following:

For all of p=1, . . . , r and S∈S^{p} z_{S}^{p}>0⇒c_{S}=min_{S′∈S}_{^{p}}c_{S′} [Math. 13]

is satisfied.

In the present embodiment, a congestion game is assumed where a different strategy set is used depending on each player, and an ϵ-approximate Wardrop equilibrium state is to be evaluated to obtain the equilibrium state of the congestion game. The ϵ-approximate Wardrop equilibrium state is defined as a state where for strategies with the proportion of players being more than 0, the cost is not larger, by a tolerance ϵ or greater, than the cost of the strategy giving a minimum cost of the strategies included in the strategy set, that is, the following:

For all of p=1, . . . , r and S∈S^{p} z_{S}^{p}>0⇒c_{S}≤min_{S′∈S}_{^{p}}c_{S′}+ϵ [Math. 14]

is satisfied. This means that it is guaranteed that the approximation error with respect to the Wardrop equilibrium state is within ϵ.

Also, if an item i∈[n] is included in the strategy S (that is, if i∈S), 1s∈{0, 1}ⁿ is assumed to be an n-dimensional vector in which the i-th element is 1 and otherwise, the i-th element is 0. With the n-dimensional vector 1s, the n-dimensional vector x^{p} with xᵢ^{p} as the ith element may be represented as follows:

x^{p}=Σ_{S∈S}_{^{p}}z_{S}^{p}1_{S}∈[0, 1]ⁿ [Math. 15]

In addition, with the n-dimensional vector x^{p}, the n-dimensional vector y with the above usage rate yᵢ as the ith element may be represented as follows:

y=Σ_{p∈[r]}m^{p}x^{p} [Math. 16]

Thus, if the cost cₛ of the strategy S is considered a function of the vector y, the function may be represented as follows:

c_{S}(y)=Σ_{i∈S}cᵢ(yᵢ) [Math. 17]

Also, with the cost function cost cₛ(·)

x=(x¹, . . . , x^{r}) [Math. 18]

is used, and the cost function C_{S} on R^{rn} may be defined as follows:

C_{S}(x):=c_{S}(Σ_{p∈[r]}m^{p}x^{p}) [Math. 19]

Also, a potential function Φ: Rⁿ->R is defined as follows:

Φ(y):=Σ_{i∈[n]}∫₀^{y}^{ᵢ}cᵢ(θ)dθ [Math. 20]

In the present embodiment, the strategy set expressed by the ZDD and the variant of the Frank-Wolfe algorithm are used to solve the minimization problem for the potential function Φ to evaluate the ϵ-approximate Wardrop equilibrium state. Note that

cᵢ(y)=∇Φ(y)ᵢ, c_{S}(y)=∇Φ(y)^{T}1_{S} [Math. 21]

holds, where ∇Φ(y)ᵢ represents the ith element of ∇Φ(y) (that is, a partial differentiation for yᵢ of Φ).

### Overall Configuration

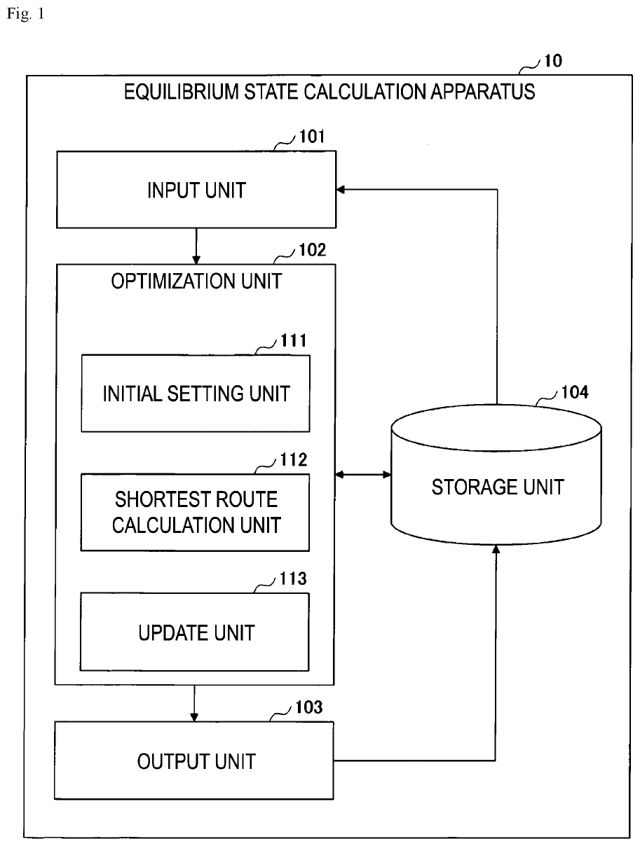

Next, an overall configuration of the equilibrium state calculation apparatus 10 according to the present embodiment will be described with reference to FIG. 1. FIG. 1 is a diagram illustrating an example of the overall configuration of the equilibrium state calculation apparatus 10 according to the present embodiment.

As illustrated in FIG. 1, the equilibrium state calculation apparatus 10 according to the present embodiment includes an input unit 101, an optimization unit 102, an output unit 103, and a storage unit 104.

The storage unit 104 stores various types of information required to calculate an ϵ-approximate Wardrop equilibrium state in a congestion game. Examples of the information stored in the storage unit 104 include an item set [n], a cost function cᵢ(yᵢ) for each item, information expressing each of one or more strategy sets by the ZDD, a set of player groups [r], a proportion m^{l}, . . . , m^{r} of players using each strategy set, and a tolerance ϵ. The strategy set expressed by the ZDD will be hereinafter represented as follows:

Z_{S}_{^{l}}, . . . Z_{S}_{^{r}} [Math. 22]

Note that in addition to the information described above, information such as a calculation process of the ϵ-approximate Wardrop equilibrium state may be stored in the storage unit 104.

Here, the ZDD representing the strategy set is a directed acyclic graph (DAG) including a node set and an edge set of directed edges connecting nodes. The node set includes, in addition to a node v representing an item, a termination node ⊥ and a termination node:

[symbol]

[Math. 23]

Also, two edges called “0-branch” and “1-branch” go out from each node v. In the present embodiment, a node pointed by the 1-branch going out from the node v is called “1-child node” and denoted by v₁. Similarly, a node pointed by the 0-branch going out from the node v is called “0-child node” and denoted by v₀. Further, a root node out of nodes v is represented as a node r.

Furthermore, each node v is imparted with an integer value 1ᵥ∈{1, . . . , n}, called a label, and the item and the node are associated with each other by the label. Note that for a termination node, a value of the label may be n+1, for example.

At this time, in the ZDD, it is ensured that the 0-branch and the 1-branch of each node direct from a node with a smaller label to a node with a larger label. That is, (label of node v)<(label of node v₀) and (label of node v)<(label of node v₁) holds for any node v. Thus, the ZDD is stratified according to a value of the label, for example, a node included in a first layer (that is, the node r) corresponds to an item 1, and the node v included in a second layer corresponds to an item 2. Thus, the node v included in an i-th layer of the ZDD corresponds to an item i.

Therefore, it is possible to express a combination of items (that is, a strategy) by each path (route) from the root node r to the termination node. That is, if an edge from the node v to a node v₁ is included in the path, an item corresponding to a label of the node v is to be included in a strategy. If an edge from the node v to a node v₀ is included in the path, an item corresponding to the label of the node v is not to be included in a strategy. With such a rule, it is possible to express a combination (strategy) by using a path.

The input unit 101 is input with various types of information such as an item set [n], a cost function cᵢ(yᵢ) for each item, one or more strategy sets expressed by the ZDD, a set of player groups [r], a proportion m^{l}, . . . m^{r} of players using each of the strategy sets, and a tolerance ϵ.

The optimization unit 102 evaluates various types of information in the ϵ-approximate Wardrop equilibrium state by processing based on the Fully-corrective Frank-Wolfe algorithm. More specifically, the optimization unit 102 solves the minimization problem for a potential function Φ by using the various types of information input through the input unit 101 to evaluate the various types of information in the ϵ-approximate Wardrop equilibrium state. As a result, it is possible to obtain a proportion zₛ^{p} of players selecting each strategy S in the ϵ-approximate Wardrop equilibrium state.

The output unit 103 outputs various types of information (such as the proportion zₛ^{p} of players selecting each strategy S in the ϵ-approximate Wardrop equilibrium state) evaluated by the optimization unit 102. Note that an output target from the output unit 103 is not limited and may be any output target. For example, the output target from the output unit 103 may be the storage unit 104, a display device such as a display, a database server connected via a communication network, or the like.

Here, the optimization unit 102 includes an initial setting unit 111, a shortest route calculation unit 112, and an update unit 113.

The initial setting unit 111 initializes various types of variables (parameters) to be updated by a variant of the Frank-Wolfe algorithm. The parameters are the above-mentioned n-dimensional vector x^{p}, an active set representing the set of strategies S currently selected by each player, and the proportion zₛ^{p} of players selecting each strategy S.

The shortest route calculation unit 112 calculates a shortest route on ZDD representing a strategy set according to the Dynamic Programming to calculate a strategy with a minimum cost in the strategy set.

The update unit 113 updates the various types of parameters by correction processing based on the Away-step Frank-Wolfe algorithm.

### Equilibrium State Calculation Processing

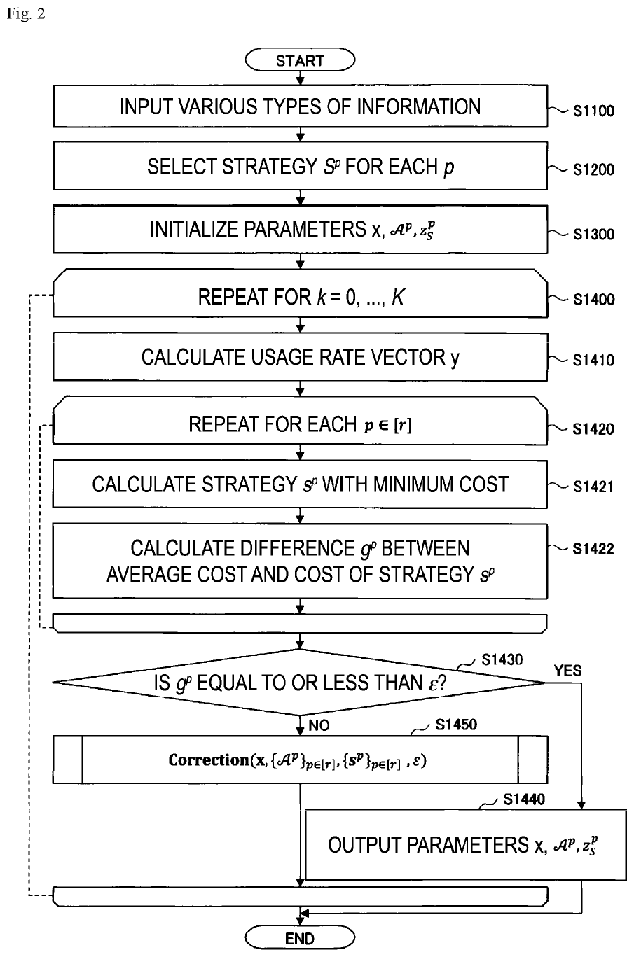

Next, equilibrium state processing for calculating an ϵ-approximate Wardrop equilibrium state of a congestion game by the equilibrium state calculation apparatus 10 according to the present embodiment will be described with reference to FIG. 2. FIG. 2 is a flowchart illustrating an example of the equilibrium state calculation processing according to the present embodiment.

In step S1100, the input unit 101 is input with various types of information (such as an item set [n], a cost function cᵢ(yᵢ) for each item, one or more strategy sets expressed by the ZDD, a set of player groups [r], a proportion m^{l}, . . . , m^{r} of players using each strategy set, or a tolerance ϵ).

In step S1200, the optimization unit 102 selects a strategy:

S^{p}∈S^{p} [Math. 24]

for each p∈[r] in the initial setting unit 111. The strategy S^{p} is a strategy firstly selected by the player group p.

In step S1300, the optimization unit 102 initializes each of various types of parameters (an n-dimensional vector x₀^{p}, an active set, and a proportion zₛ^{p} of players selecting each strategy S) in the initial setting unit 111, as follows:

x₀^{p}=1_{S}_{^{p}}, [symbol] ₀^{p}={S^{p}}, z_{S}_{^{p}}^{p}=1 [Math. 25]

Also, for simplicity, the following equation:

x₀=(x₀¹, . . . , x₀^{r}) [Math. 26]

is used.

In step S1400, the optimization unit 102 repeatedly executes steps S1410 to S1450 for k=0, 1, . . . , K, where k denotes an index representing the number of repetitions. Here, K is a hyperparameter set in advance. Note that, in the following description of steps S1410 to S1450, a case in which the number of repetitions is kth is described, and a lower right index of the various types of symbols excluding z represents the number of repetitions. For example, an n-dimensional vector yₖ represents an n-dimensional vector y obtained when the number of repetitions is kth.

In step S1410, the optimization unit 102 calculates an n-dimensional vector yₖ with the usage rate yᵢ as the ith element by the following equation:

yₖ=Σ_{p∈[r]}m^{p}xₖ^{p} [Math. 27]

In step S1420, the optimization unit 102 repeatedly executes steps S1421 to S1422 for each p∈[r]. Note that in the following description of steps S1421 to S1422, steps S1421 to S1422 for a certain p will be focused.

In step S1421, the optimization unit 102 calculates, in the shortest route calculation unit 112, the shortest route on ZDD:

Z_{S}_{^{p}} [Math. 28]

by the Dynamic Programming to calculate a strategy sₖ^{p} with a minimum cost in a strategy set corresponding to p. That is, the shortest route calculation unit 112 calculates the shortest route on the ZDD representing the strategy set corresponding to p to calculate

sₖ^{p}∈argmin_{μ∈S}_{^{p}} [symbol] ∇Φ(yₖ), μ [symbol] [Math. 29]

Note that <·, >· represents an inner product.

Specifically, the shortest route calculation unit 112 calculates the strategy sₖ^{p} as follows.

First, the shortest route calculation unit 112 sets a distance of the 0-branch to 0 and a distance of the 1-branch to:

∇Φ(yₖ)lᵥ [Math. 30]

for each node v on the ZDD. That is, the distance of the 1-branch of the node v is considered a cost of the item corresponding to the label of the node v.

The shortest route calculating unit 112 calculates, by using the Dynamic Programming, a path (shortest route) which is from the root node r to the termination node and where the sum of the distances is minimum. As a result, a combination of items represented by the path for minimizing the distance on the ZDD is obtained as a strategy sₖ^{p} with a minimum cost in the strategy set corresponding to p. A method of calculating a shortest route on a directed acyclic graph such as ZDD is widely known, and for example, refer to Reference Document 5 “Tetsuo Shibuya, ‘Information Engineering Algorithm’, Maruzen Publishing, November 2016” and the like.

In step S1422, the optimization unit 102 calculates a difference gₖ^{p} between an average cost of players using the strategy set corresponding to p in the current state and a cost of the strategy with a minimum cost in such a strategy set (that is, the strategy sₖ^{p}). That is, the optimization unit 102 uses

dₖ^{p}=sₖ^{p}−xₖ^{p} [Math. 31]

to calculate

gₖ^{p}= [symbol] −∇Φ(yₖ), dₖ^{p} [symbol] [Math. 32]

Note that <−∇Φ(yₖ), dₖ^{p}>=<∇Φ(yₖ), xₖ^{p}>−<∇Φ(yₖ), sₖ^{p}>, and <∇Φ(yₖ), xₖ^{p}> represents the average cost for players using the strategy set corresponding to p and <∇Φ(yₖ) sₖ^{p}> represents the cost of the strategy sₖ^{p}.

In step S1430, the optimization unit 102 determines, for all p∈[r], whether the difference gₖ^{p} between the average cost and the cost of the strategy with a minimum cost is equal to or less than the tolerance ϵ. That is, the optimization unit 102 determines whether

max_{p∈[r]}gₖ^{p}≤ϵ [Math. 33]

is satisfied.

If it is determined that gₖ^{p} is equal to or less than the tolerance ϵ for all p∈[r] (YES in step S1430), step S1440 is executed, and otherwise (NO in step S1430), step S1440 is not executed.

In step S1440, the output unit 103 outputs current parameters:

xₖ, { [symbol] ₖ^{p}}_{p∈[r]}, {{z_{S}^{p} [symbol] }_{p∈[r]} [Math. 34]

These parameters are an n-dimensional vector x, an active set, and a proportion of players selecting each strategy, respectively in the ϵ-approximate Wardrop equilibrium state. Note that a reason that these parameters satisfy the ϵ-approximate Wardrop equilibrium state will be described later.

In step S1450, the optimization unit 102 executes the correction processing in the update unit 113 to update various types of parameters. That is, the optimization unit 102 calls a subroutine:

Correction(xₖ, { [symbol] ₖ^{p}}_{p∈[r]}, {sₖ^{p}}_{p∈[r]}, ϵ) [Math. 35]

to obtain updated parameters:

xₖ₊₁=(xₖ₊₁¹, . . . , xₖ₊₁^{r}), { [symbol] ₖ₊₁^{p}}_{p∈[r]}, {{z_{S}^{p} [symbol] }_{p∈[r]} [Math. 36]

### Correction Processing

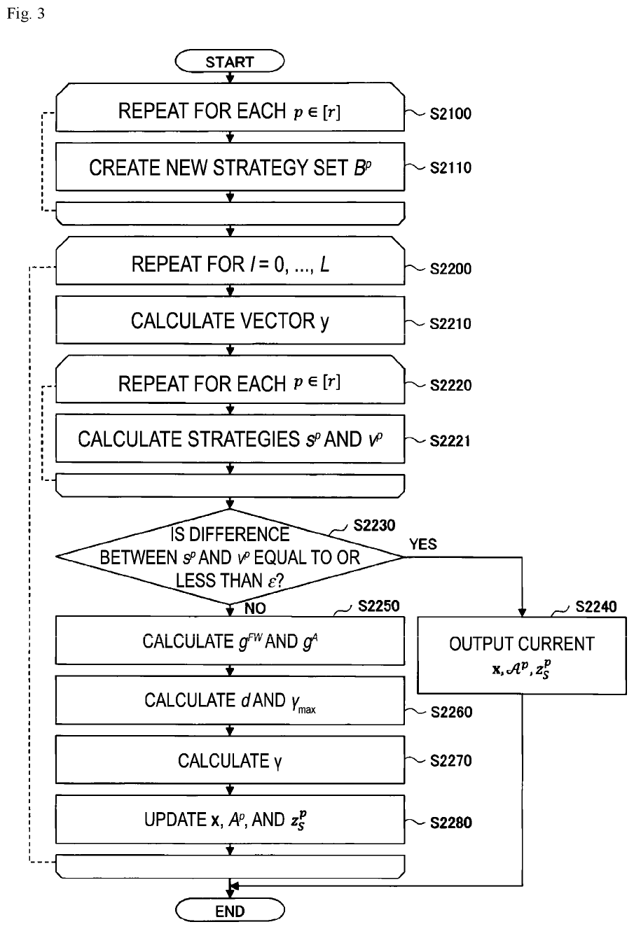

Here, the above correction processing in step S1450 will be described in detail with reference to FIG. 3. FIG. 3 is a flowchart illustrating an example of the correction processing according to the present embodiment. Note that for simplicity, the following description is provided on the assumption that the index k in step S1400 in FIG. 2 is omitted and the subroutine:

Correction(x, { [symbol] ^{p}}_{p∈[r], {s}^{p}}_{p∈[r], ϵ)} [Math. 37]

is called. Note that x₀=x=(x^{l}, . . . , x^{r}).

In step S2100, the update unit 113 repeatedly executes step S2110 for each p∈[r]. Note that in the following description of step S2110, step S2110 for a certain p will be focused.

In step S2110, the update unit 113 uses

[symbol]

₀^{p}= [symbol] ^{p} [Math. 38]

to create a new strategy set:

[symbol]

^{p}= [symbol] ^{p}∪{s^{p}} [Math. 39]

In step S2200, the update unit 113 repeatedly executes steps S2210 to S2280 for 1=0, 1, . . . , L, where 1 denotes the index representing the number of repetitions. L is a hyperparameter set in advance. Note that, in the following description of steps S2210 to S2280, a case in which the number of repetitions is lth is described, and a lower right index of various types of symbols excluding z represents the number of repetitions. For example, an n-dimensional vector yₗ represents an n-dimensional vector y when the number of repetitions is lth.

In step S2210, the update unit 113 calculates an n-dimensional vector yₗ with the usage rate yᵢ as the ith element as follows:

[Math. 40]

In step S2220, the update unit 113 repeatedly executes step S2221 for each p∈[r]. However, if step S2240 is executed, the correction processing is ended and the processing returns to the caller of the subroutine. Note that in the following description of step S2221, step S2221 for a certain p will be focused.

In step S2221, at this point of time, the update unit 113 calculates a strategy sip with a minimum cost in the new strategy set corresponding to p and a strategy vₗ^{p} with a maximum cost in the active strategy set corresponding to p. Specifically, the update unit 113 calculates

sₗ^{p}∈ [symbol] [symbol] ∇Φ(yₗ), μ

[symbol]

vₗ^{p}∈ [symbol] [symbol] ∇Φ(yₗ), μ [symbol] [Math. 41]

At this time, the update unit 113 also calculates

dₗ^{p,FW}=sₗ^{p}−xₗ^{p}

dₗ^{p,A}=xₗ^{p}−vₗ^{p} [Math. 42]

where dₗ^{p,FW} represents a direction from x^{p} toward the strategy sₗ^{p} with a minimum cost, and dₗ^{p,A} represents a direction opposite to a direction from x^{p} toward the strategy vₗ^{p} with a maximum cost.

Note that in the above step S2221, the update unit 113 may calculate the cost for each strategy to calculate the strategy sₗ^{p} and the strategy vₗ^{p}. This is because the size of the new strategy set or the active set corresponding to p is very small (at most about O(n)) compared to the strategy set corresponding to p.

In step S2230, the update unit 113 determines whether a difference between the cost of the strategy vₗ^{p} and the cost of the strategy sₗ^{p} is equal to or less than the tolerance ϵ for all p∈[r]. That is, the update unit 113 determines whether

[Math. 43]

is satisfied. Note that the above inner product portion is <∇Φ(yₗ), vₗ^{p}>−<∇Φ(yₗ), sₗ^{p}>, and <∇Φ(yₗ), vₗ^{p}> represents the cost of the strategy Vₗ^{p}, <∇Φ(yₗ), sₗ^{p}> represents the cost of the strategy sₗ^{p}, respectively.

If it is determined that the difference between the cost of the strategy vₗ^{p} and the cost of the strategy sₗ^{p} for all of p∈[r] is equal to or less than the tolerance ϵ (YES in step S2230), step S2240 is executed. Otherwise (NO in step S2230), steps S2250 to S2280 are executed.

In step S2240, the update unit 113 updates parameters:

xₗ, { [symbol] ₗ^{p}}_{p∈[r]} [Math. 44]

to

xₖ₊₁, { [symbol] ₖ₊₁^{p}}_{p∈[r]} [Math. 45]

respectively to output (that is, output, to the caller of the subroutine,) current parameters:

xₖ₊₁, { [symbol] ₖ₊₁^{p}}_{p∈[r]}, {{z_{S}^{p} [symbol] }_{p∈[r]} [Math. 46]

The update unit 113 ends the correction processing and the processing returns to the caller of the subroutine.

In step S2250, the update unit 113 uses

gₗ^{FW}=Σ_{p∈[r]}m^{p} [symbol] −∇Φ(yₗ), dₗ^{p,FW}

[symbol]

gₗ^{A}=Σ_{p∈[r]}m^{p} [symbol] −∇Φ(yₗ), dₗ^{p,A} [symbol] [Math. 47]

to calculate gₗ^{FW} and gₗ^{A}

In step S2260, the update unit 113 calculates dₗ and γₘₐₓ according to the magnitude relationship between gₗ^{FW} and gₗ^{A}. That is, if gₗ^{FW}≥gₗ^{A}, the update unit 113 uses

dₗ=(dₗ^{1,FW}, . . . , dₗ^{r,FW}), γₘₐₓ=1 [Math. 48]

to calculate dₗ and γₘₐₓ, and if gₗ^{FW}<gₗ^{A}, the update unit 113 uses

$${d}_{l} = ( {d}_{l}^{1 , A} , … , {d}_{l}^{r , A} ) , {γ}_{m a x} = {min}_{p ∈ [ r ]} {z}_{{v}_{l}^{p}}^{p} / ( 1 - {z}_{{v}_{l}^{p}}^{p} ) \qquad [ Math . 49 ]$$

to calculate dₗ and γₘₐₓ. This means that when xₗ is updated, if gₗ^{FW}≥gₗ^{A}, x^{p} is advanced in the direction of dₗ^{p,FW}, and if gₗ^{FW}≥gₗ^{A} does not hold, x^{p} is advanced in the direction of dₗ^{p,A}.

In step S2270, the update unit 113 uses

γₗ∈argmin_{γ∈[0,γ}_{ₘₐₓ}]F(xₗ+γdₗ) [Math. 50]

to calculate γₗ, where the function F is

$$F ( x ) := Φ ( {\sum }_{p ∈ [ r ]} {m}^{p} {x}^{p} ) \qquad [ Math . 51 ]$$

That is, the update unit 113 evaluates a point γₗ at which a value of the function F is minimum in advancing in the direction from xₗ to dₗ. This may be evaluated, for example, by line search.

In step S2280, the update unit 113 updates the parameters. Here, the update unit 113 updates the parameters as follows.

Firstly, the update unit 113 updates xₗ as follows:

xₗ₊₁=xₗ+γₗdₗ [Math. 52]

This means that x at which the value of the function F is minimum at this point of time is replaced with xₗ₊₁.

In addition, if gₗ^{FW}≥gₗ^{A}, the update unit 113 updates the proportion z of players selecting each strategy for each p∈[r] according to

zₛ_{^{p}}^{p}←(1−γ)zₛ_{^{p}}^{p}+γ

z_{S}^{p}←(1−γ)z_{S}^{p}, S∈ [symbol] ^{p}\{s^{p}} [Math. 53]

On the other hand, if gₗ^{FW}<gₗ^{A}, the update unit 113 updates the proportion z for each p∈[r] according to

zᵥ_{^{p}}^{p}←(1+γ)zᵥ_{^{p}}^{p}−γ

z_{S}^{p}←(1+γ)z_{S}^{p}, S∈ [symbol] ^{p}\{v^{p}} [Math. 54]

Note that, for example, the Reference Document 4 and the like should be referred to for the method for updating the proportion z of players selecting each strategy.

Further, the update unit 113 updates the active set for each p∈[r] according to

[symbol]

ₗ₊₁^{p}={S∈ [symbol] ^{p}|z_{S}^{p}≤0} [Math. 55]

That is, only the strategies satisfying zₛ^{p}>0 are collected into a new active set.

Reason for Parameter to Satisfy ϵ-Approximate Wardrop Equilibrium State Now, a reason why the parameters output in the equilibrium state calculation processing satisfy the ϵ-approximate Wardrop equilibrium state will be described. When the cost function C_{S} is used, the ϵ-approximate Wardrop equilibrium state may be put into a state where if one arbitrary p∈[r] is fixed, for arbitrary

S∈ [symbol] ^{p}, S′∈S^{p} [Math. 56]

the parameter x output in the equilibrium state calculation processing satisfies

C_{S}(x)−ϵ≤C_{S′}(x)+ϵ [Math. 57]

From step S1430 in FIG. 2, establishment of

$$〈 ▽ Φ ( y ) , {x}^{p} 〉 \leq {min}_{u ∈ {S}^{p}} 〈 ▽ Φ ( y ) , u 〉 + ϵ = {min}_{{S}^{′} ∈ {S}^{p}} {C}_{{S}^{′}} ( x ) + ϵ \qquad [ Math . 58 ]$$

is guaranteed. On the other hand, from step S2230 in FIG. 3, establishment of

$$〈 ▽Φ ( y ) , {x}^{p} 〉 \geq 〈 ▽Φ ( y ) , u 〉 - ϵ = {C}_{S} ( x ) - ϵ \qquad [ Math . 59 ]$$

is guaranteed.

Thus, from the two inequalities described above, C_{S}(x)−ϵ≤C_{S′}(x)+ϵ holds. Therefore, the parameters output in the equilibrium state calculation processing satisfy the ϵ-approximate Wardrop equilibrium state.

### Hardware Configuration

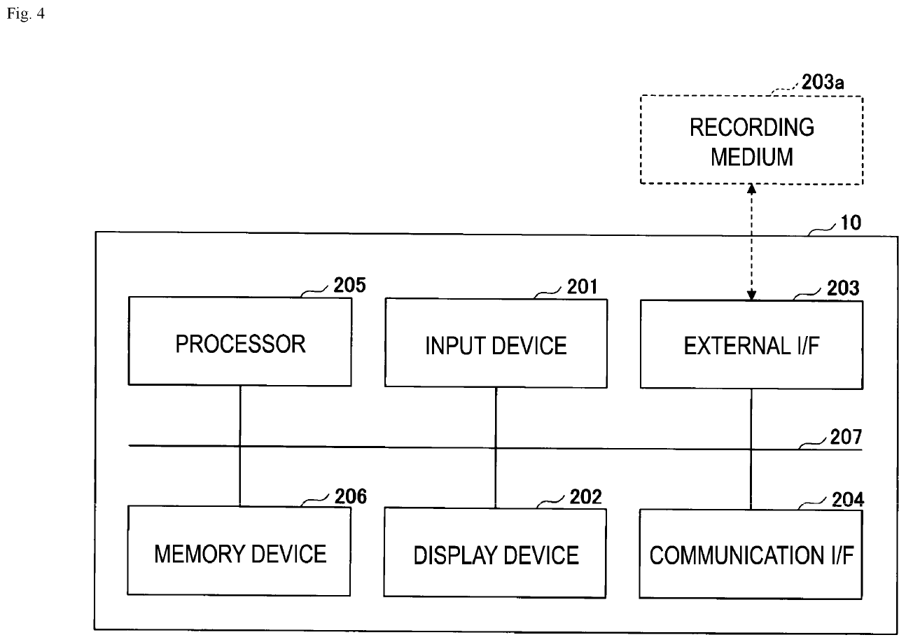

Next, a hardware configuration of the equilibrium state calculation apparatus 10 according to the present embodiment will be described with reference to FIG. 4. FIG. 4 is a diagram illustrating an example of the hardware configuration of the equilibrium state calculation apparatus 10 according to the present embodiment.

As illustrated in FIG. 4, the equilibrium state calculation apparatus 10 according to the present embodiment is realized by a general computer or computer system, and includes an input device 201, a display device 202, an external I/F 203, a communication I/F 204, a processor 205, and a memory device 206. The pieces of hardware are communicatively connected via a bus 207.

The input device 201 is, for example, a keyboard, a mouse, or a touch panel. The display device 202 is, for example, a display. Note that the equilibrium state calculation apparatus 10 does not need to include at least one of the input device 201 and the display device 202.

The external I/F 203 is an interface with an external device. The external device includes a recording medium 203a, for example. The equilibrium state calculation apparatus 10 can read from or write to the recording medium 203a via the external I/F 203. In the recording medium 203a, one or more programs for realizing each functional unit (the input unit 101, the optimization unit 102, and the output unit 103) provided in the equilibrium state calculation apparatus 10 may be stored, for example.

Examples of the recording medium 203a include a compact disc (CD), a digital versatile disk (DVD), a secure digital memory card (SD memory card), and a universal serial bus (USB) memory card.

The communication I/F 204 is an interface for connecting the equilibrium state calculation apparatus 10 to a communication network. Note that the one or more programs for realizing each functional unit provided in the equilibrium state calculation apparatus 10 may be acquired (downloaded) from a predetermined server device and the like via the communication I/F 204.

The processor 205 is, for example, various calculation devices such as a central processing unit (CPU) or a graphics processing unit (GPU). Each functional unit provided in the equilibrium state calculation apparatus 10 is realized by processing of causing the processor 205 to execute one or more programs stored in the memory device 206 or the like.

The memory device 206 is, for example, any storage device such as a hard disk drive (HDD), a solid state drive (SSD), a random access memory (RAM), a read only memory (ROM), or a flash memory. The storage unit 104 provided in the equilibrium state calculation apparatus 10 may be realized using, for example, the memory device 206. Note that the storage unit 104 may be realized by using, for example, a storage device connected to the equilibrium state calculation apparatus 10 via the communication network N.

The equilibrium state calculation apparatus 10 according to the embodiment can realize the equilibrium state calculation processing described above by having the hardware configuration illustrated in FIG. 4. Note that the hardware configuration illustrated in FIG. 4 is an example and the equilibrium state calculation apparatus 10 may have another hardware configuration. For example, the equilibrium state calculation apparatus 10 may have a plurality of processors 205 or may have a plurality of memory devices 206.

### Conclusion

As described above, the equilibrium state calculation apparatus 10 according to the present embodiment may obtain, at high speed for practical use, an equilibrium state (ϵ-approximate Wardrop equilibrium state) with an approximation accuracy guaranteed in even a congestion game including a general strategy set. As a result, for example, it is possible to calculate an equilibrium state at high speed for practical use, for example, for a congestion game modeling a complex situation such as communication among multi points or communication between two points with budget restrictions.

Therefore, for example, in designing a communication network or a high-speed network, it is possible to simulate a level of congestion generated in each communication path or on each road due to such design and a level of an actual cost of a player. Thus, for example, when there are a plurality of ideas for the design, it is possible to make a performance comparison in the simulation.

Note that the present inventor confirms, with the equilibrium state calculation apparatus 10 according to the present embodiment, a case where calculation of an equilibrium state is about 1000 times faster than when all contents of a strategy set are enumerated, and a case where calculation of an equilibrium state is completed in a few seconds even if it is not possible to enumerate all contents of a strategy set due to memory and time restrictions.

The present invention is not limited to the above-described embodiment disclosed specifically, and various modifications or changes, combinations with known techniques, and the like can be made without departing from description of the claims.

### REFERENCE SIGNS LIST

10 Equilibrium state calculation apparatus

101 Input unit

102 Optimization unit

103 Output unit

104 Storage unit

111 Initial setting unit

112 Shortest route calculation unit

113 Update unit

1. An equilibrium state calculation apparatus for calculating an equilibrium state of a congestion game comprising a processor configured to execute a method comprising:
receiving input associated with with graph information representing a set of strategies represented by a combination of items, in a zero-suppressed binary decision diagram, the strategies used by a player of the congestion game; and
calculating, by using the input, equilibrium state information including a proportion of players selecting the strategies in the equilibrium state by a variant of the Frank-Wolfe algorithm.

2. The equilibrium state calculation apparatus according to claim 1, wherein the calculating further comprises:
searching a shortest route from a root node to a termination node of a zero-suppressed binary decision diagram by Dynamic Programming for a node of the zero-suppressed binary decision diagram represented by the graph information when a distance of a 0-branch of the node is 0 and a distance of a 1-branch of the node is a cost of an item corresponding to the node, to calculate a first cost minimum strategy representing a strategy with the cost being minimum, and
updating the equilibrium state information by using the first cost minimum strategy.

3. The equilibrium state calculation apparatus according to claim 2, wherein
the calculating further comprises
repeatedly executing the calculation of the first cost minimum strategy and the update of the equilibrium state information until a difference between an average cost for players using the set of strategies and the cost of the first cost minimum strategy is a predetermined tolerance or less.

4. The equilibrium state calculation apparatus according to claim 2, wherein
the calculating further comprises
updating the equilibrium state information by an algorithm based on the Away-step Frank-Wolfe algorithm by using the first cost minimum strategy.

5. The equilibrium state calculation apparatus according to claim 2, wherein
the calculating further comprises
calculating a second cost minimum strategy representing a strategy with a minimum cost in a new strategy set by using the new strategy set created from the first cost minimum strategy and an active set representing a set of strategies currently selected by the player,
calculating a cost maximum strategy representing a strategy with a maximum cost in the active set, and
updating the equilibrium state information by using the cost maximum strategy and the second cost minimum strategy.

6. The equilibrium state calculation apparatus according to claim 5, wherein
the calculating further comprises
repeatedly executing the update of the equilibrium state information until a difference between the cost maximum strategy and the second cost minimum strategy is a predetermined tolerance or less.

7. An equilibrium state calculation method for calculating an equilibrium state of a congestion game, comprising:
receiving input associated with graph information representing a set of strategies represented by a combination of items, in a zero-suppressed binary decision diagram, the strategies used by a player of the congestion game; and
calculating, by using the input, equilibrium state information including a proportion of players selecting the strategies in the equilibrium state by a variant of the Frank-Wolfe algorithm.

8. A computer-readable non-transitory recording medium storing computer-executable program instructions that when executed by a processor cause a computer to execute a method comprising:
receiving input associated with with graph information representing a set of strategies represented by a combination of items, in a zero-suppressed binary decision diagram, the strategies used by a player of the congestion game; and
calculating, by using the input, equilibrium state information including a proportion of players selecting the strategies in the equilibrium state by a variant of the Frank-Wolfe algorithm.

9. The equilibrium state calculation apparatus according to claim 3, wherein
the calculating further comprises
updating the equilibrium state information by an algorithm based on the Away-step Frank-Wolfe algorithm by using the first cost minimum strategy.

10. The equilibrium state calculation method according to claim 7, wherein the calculating further comprises:
searching a shortest route from a root node to a termination node of a zero-suppressed binary decision diagram by Dynamic Programming for a node of the zero-suppressed binary decision diagram represented by the graph information when a distance of a 0-branch of the node is 0 and a distance of a 1-branch of the node is a cost of an item corresponding to the node, to calculate a first cost minimum strategy representing a strategy with the cost being minimum, and
updating the equilibrium state information by using the first cost minimum strategy.

11. The equilibrium state calculation method according to claim 10,
wherein
the calculating further comprises
repeatedly executing the calculation of the first cost minimum strategy and the update of the equilibrium state information until a difference between an average cost for players using the set of strategies and the cost of the first cost minimum strategy is a predetermined tolerance or less.

12. The equilibrium state calculation method according to claim 10, wherein
the calculating further comprises
updating the equilibrium state information by an algorithm based on the Away-step Frank-Wolfe algorithm by using the first cost minimum strategy.

13. The equilibrium state calculation method according to claim 10, wherein
the calculating further comprises
calculating a second cost minimum strategy representing a strategy with a minimum cost in a new strategy set by using the new strategy set created from the first cost minimum strategy and an active set representing a set of strategies currently selected by the player,
calculating a cost maximum strategy representing a strategy with a maximum cost in the active set, and
updating the equilibrium state information by using the cost maximum strategy and the second cost minimum strategy.

14. The equilibrium state calculation method according to claim 11,
the calculating further comprises
updating the equilibrium state information by an algorithm based on the Away-step Frank-Wolfe algorithm by using the first cost minimum strategy.

15. The equilibrium state calculation method according to claim 13, wherein
the calculating further comprises
repeatedly executing the update of the equilibrium state information until a difference between the cost maximum strategy and the second cost minimum strategy is a predetermined tolerance or less.

16. The computer-readable non-transitory recording medium according to claim 8, wherein the calculating further comprises:
searching a shortest route from a root node to a termination node of a zero-suppressed binary decision diagram by Dynamic Programming for a node of the zero-suppressed binary decision diagram represented by the graph information when a distance of a 0-branch of the node is 0 and a distance of a 1-branch of the node is a cost of an item corresponding to the node, to calculate a first cost minimum strategy representing a strategy with the cost being minimum, and
updating the equilibrium state information by using the first cost minimum strategy.

17. The computer-readable non-transitory recording medium according to claim 16,
wherein
the calculating further comprises
repeatedly executing the calculation of the first cost minimum strategy and the update of the equilibrium state information until a difference between an average cost for players using the set of strategies and the cost of the first cost minimum strategy is a predetermined tolerance or less.

18. The computer-readable non-transitory recording medium according to claim 16,
the calculating further comprises
updating the equilibrium state information by an algorithm based on the Away-step Frank-Wolfe algorithm by using the first cost minimum strategy.

19. The computer-readable non-transitory recording medium according to claim 16,
the calculating further comprises
calculating a second cost minimum strategy representing a strategy with a minimum cost in a new strategy set by using the new strategy set created from the first cost minimum strategy and an active set representing a set of strategies currently selected by the player,
calculating a cost maximum strategy representing a strategy with a maximum cost in the active set, and
updating the equilibrium state information by using the cost maximum strategy and the second cost minimum strategy.

20. The computer-readable non-transitory recording medium according to claim 19, wherein
the calculating further comprises
repeatedly executing the update of the equilibrium state information until a difference between the cost maximum strategy and the second cost minimum strategy is a predetermined tolerance or less.
